(19) United States
(12) Patent Application Publication
(10) Pub. No.: US 2011/0057000 A1
(43) Pub. Date: Mar. 10, 2011

(54) THREADED ADAPTER BETWEEN SHANK AND TAP

(76) Inventor: Paul Mallon, Dublin (IE)

(21) Appl. No.: 12/991,368

(22) PCT Filed: May 13, 2008
(86) PCT No.: PCT/EP08/03828

§ 371 Date: Nov. 5, 2010

(51) Int. Cl. B67D 1/14; B65D 25/40

(52) U.S. Cl. 222/568

(57) ABSTRACT

The invention relates to a device that is suitable for use with a beverage dispensing apparatus for dispensing a beverage, for example beer. The inventive device comprises a first opening at one end adapted to cooperate with a control flow faucet having a first dimension, and a second opening at the opposite end of the device adapted to cooperate with a shank having a second dimension to provide a flow path for dispensing a beverage from said shank through said control flow faucet. The advantage of the present invention is that the device serves as an interface and adapter between the control flow faucet and the shank having different dimensions.

### FIELD OF THE INVENTION

The invention relates to a device for use in a beverage dispensing apparatus. In particular the invention relates to a device for use in dispensing beer or other draught beverages and the like.

### BACKGROUND TO THE INVENTION

Beverage dispensers are well known in the art. One of most common types of beverage dispensers is for dispensing alcoholic drinks, for example beer. Typically a beer dispensing apparatus is designed to dispense beer which is delivered from a beer storage area, for example a keg, to a dispensing point under pressure for dispensing. Dispensing apparatus of this type typically comprises a standard flow control faucet and a valve which is movable from an off position to an on position to allow beer to flow through the valve. This type of dispensing apparatus is well known throughout the beverage dispensing industry.

There are various types of known flow control faucets, for example the Universal or SI tap allows a user to adjust the flow rate of the beverage at the front end of the tap. Another type of tap is the Celli, IMI or the SK tap, which allows a user to adjust the flow rate of the beverage at the side of the tap by adjusting a lever up or down depending on the rate of speed at which the beverage is being dispensed.

A problem in the beverage dispensing industry is that there is no common standard for the flow control faucet. For example, for draught beer dispensers the standard European flow control faucet is not the same as the American or Asian beverage dispensing apparatus as they are of different dimension. This is problematic in the industry as there is no way of installing a standard European flow control faucet to replace a faucet conforming with the American/Asian standard. In practice what is required is that the entire shank has to be changed to conform with the particular faucet dimension. In some cases this is not possible where the front/tower is factory made or sealed on site resulting in the necessity for a complete replacement of the beverage dispenser.

Another problem occurs with the free flow faucet is that the rate of speed or flow rate of the product is determined by the external pressure of gas supplied to the beverage as well as the equilibrium pressure that is around the beverage. If the product requires a high pressure to equilibrate the system, and keep associated intrinsic dissolved CO₂ content of the product in solution, then the free flow faucet does not allow for any restriction of the flow rate. As a result this causes waste beverage for the end user. For example, if the beverage or beer is dispensed into a vessel at a fast rate it will cause a gas break out, thus resulting in high or foaming beer causing waste product. If the product flow rate cannot be controlled then the correct equilibrium pressure cannot be applied as the product will pour at a rate which induces foaming. This is highly undesirable when dispensing beverages.

There is therefore a need to provide a device to overcome the above mentioned problems.

### SUMMARY OF THE INVENTION

According to the invention there is provided, as set out in the appended claims, a device, suitable for use with a beverage dispensing apparatus for dispensing a beverage, said device comprises a first opening at one end adapted to cooperate with a control flow faucet having a first dimension, and a second opening at the opposite end of the device adapted to cooperate with a shank having a second dimension to provide a flow path for dispensing a beverage from said shank through said control flow faucet.

The advantage of the present invention is that the device serves as an interface and adapter between the control flow faucet and the shank having different dimensions. The design of the device does not allow the break out of gas associated with the beverage, which causes unwanted wastage due to foaming.

Suitably, the device comprises a threaded portion for cooperating with a flange of the control flow faucet.

Suitably, the device comprises a tapered portion tapered towards the opposite end to said second opening to connect with said shank. Preferably, the tapered end connects with said shank to provide a seal to allow a flow path between said control flow faucet and said shank.

It will be appreciated that a flange is provided at the tapered end to cooperate with a thread on the shank to provide a seal. The device of the present invention is designed so that the tapered section of the device allows for the flow path to be reduced gradually without allowing a gas break out in the draught beverage. A particularly suitable angle for tapering the device is approximately between 30 to 45 degrees to prevent a gas break out in the beverage been dispensed.

In one embodiment the threaded portion is separate to the tapered portion when said device is not in use. The threaded portion can cooperate with the separate tapered portion in use to provide a flow path for dispensing a draught beverage from said shank through said control flow faucet.

### BRIEF DESCRIPTION OF THE DRAWINGS

The invention will be more clearly understood from the following description of an embodiment thereof, given by way of example only, with reference to the accompanying drawings, in which:—

FIG. 1 illustrates the device according to the present invention;

FIG. 2 illustrates a faucet and a shank of a known beverage dispensing apparatus;

FIG. 3 illustrates the device in operation with part of a beverage dispensing apparatus of FIG. 2 according to one aspect of the invention; and

FIG. 4 illustrates a further embodiment of the device according to the present invention.

### DETAILED DESCRIPTION OF THE DRAWINGS

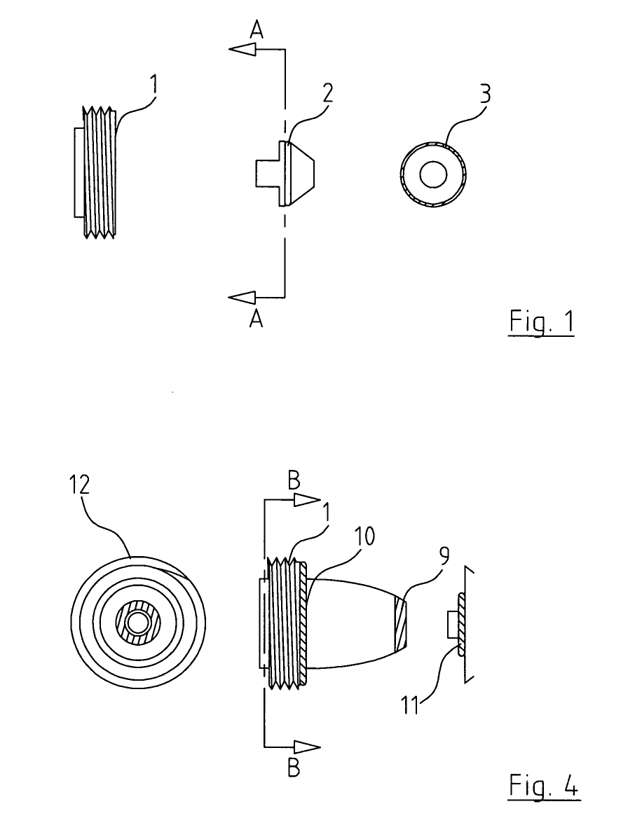

Referring to FIG. 1 there is illustrated the device according to the present invention. The device comprises a threaded section (1) and a tapered section (2). Reference numeral (3) shows a cross sectional view of the tapered portion (2).

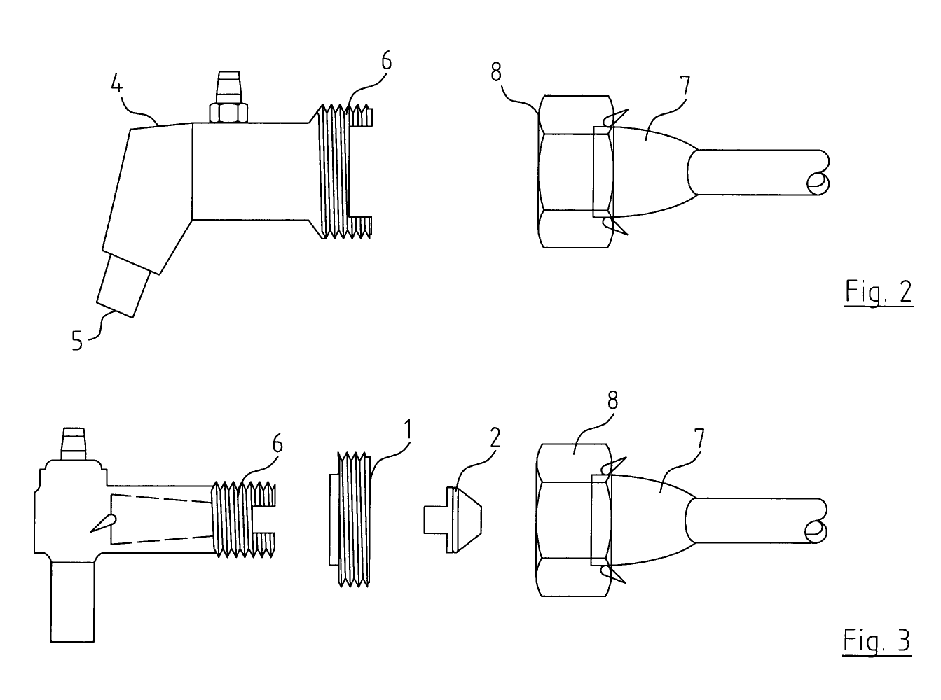

Referring to FIG. 2 there is illustrated a typical control flow faucet (4) having an outlet (5) for a beverage to be dispensed. Associated with the control flow faucet is a threaded portion (6). A shank (7) is provided with a locking means (8), for example a locking nut. The shank (7) is typically attached via tubing or some conveying means to a beverage storage area, for example a keg (not shown).

FIG. 3 shows the device of the present invention in operation. The threaded portion (1) of the device is dimensioned to fit to the threaded portion (6) of the tap (4). The threaded portion (1) can be dimensioned to fit the standard flow control faucet either using European or US standard dimensions. Suitably the threaded portion (1) co-operates with the threaded portion (6) of the faucet (4) by threading to secure onto a flange. The threaded portions (1) and (6) forms an airtight seal around the faucet. The tapered portion (2) connects to the threaded portion (1) either using a snap in connection or a further threaded portion to securely attach to the inside surface of the threaded portion (1). Finally, the tapered portion (2) is tapered at one end to connect with the shank (7). A locking means (8), for example a locking nut, is provided to ensure the tapered portion (2) connects with the shank (7) to form an airtight seal.

The device of the present invention allows the standard flow control faucet (4) to be fitted directly to a different dimensioned shank (7). The device is designed to accommodate various standard flow control faucet (4) and other products, which have a flow restriction valve to fit other standard dimensioned shanks. It will be appreciated that the device of the present invention can be made from any type of suitable metal or hard plastics material.

It will be appreciated that the purpose of the device is to install with ease and without replacing the standard American/Asian shank to any standard flow control faucet (4) or dispensing tap in Europe. This is especially advantageous for a sealed beverage dispensing unit where access to the shank (7) is not permitted.

The design of the device does not allow the break out of gas which typically causes foaming. Due to the design of the device, the device can be inserted inside the existing standard American/Asian shank (7) and held in place by the existing faucet (4) threaded portion or flange. Thus the device of the present invention serves as an interface between the standard flow control tap and the standard American/Asian shank. The device allows a straight path for the product to the dispense point at outlet (5). In effect the device of the present invention acts as a type of flow regulator.

Typical dimensions of the control flow faucet and the shank can vary. For example, European standard faucets have a ⅜ inch thread such as the Celli, IMI and SK taps mentioned above. The standard SI tap typically comprises a ½ inch thread. For US and Asian shanks typically have 1 inch or ⅞ inch thread. These dimensions can vary and are known in the beverage industry.

It will be appreciated the device of the present invention enables the standard flow control faucet (4) to be inserted into the standard American/Asian shank (7) and connected by the American/Asian threaded portion or flange, hence creating a seal and allowing a beverage to be dispensed without gas breakout in the form of foam. The resulting flow control and reduction in the flow rate allows the pressure of the beverage to be increased to the desired equilibrium pressure for each individual product.

It will be appreciated that the device of the present invention can be dimensioned to operate in reverse to the above and be adapted to fit a European standard shank to an American standard faucet.

The device allows a dispensing beverage apparatus to be balanced with the correct pressure and keep any CO₂ in solution, thus avoiding foaming at the faucet and producing associated product waste. Typically the interior of a keg stores beer and CO₂. To maintain this form of carbonation it is essential to prevent gas outbreak in the product and avoid dispensing problems. The head space in the tap must be filled with gas so that the pressure provided in the head space acts to keep the beers natural carbonation intact and in balance from the keg to a glass. It will be appreciated that various beers, which are on the market today have more CO₂ content and as a result require a lot more head pressure and thus the flow needs to be slowed down at the dispensing point. The invention achieves this by the device in combination with a known flow tap so that the pressure is regulated to provide a safe amount of pressure, thus adjusting the flow rate of the tap. In particular it was found that adjusting the length of the device by tapering the device of the present invention at an angle of approximately between 30 and 45 degrees ensures that regulation of the beverage is achieved.

Referring now to FIG. 4 there is illustrated another embodiment of the present invention. In this embodiment the threaded portion (1) and the tapered portion (2) forms a single piece and may be integrally formed. The threaded portion is adapted to securely screw onto a thread of the faucet or tap of a first dimension. The tapered portion (2) engages a shank of a second dimension in a similar fashion as set out above. A nylon plastic seal (9) provides a seal inside the shank when in use. A washer (10) increases the strength of the seal and prevents any possible leaks. An additional washer (11) is provided to seal the device to the faucet (6) in use. Reference numeral 12 illustrates a cross sectional view of the device (1, 2). It will be appreciated that the design of the device can be designed to fit any faucet/tap. For example, the CELLI or SK faucets have a wider flange and a shorter neck where a washer is placed over a flow connection and compressed against the have of the tap to from a seal.

It will be appreciated that the device of the present invention can be made from any type of suitable material, for example metal such as copper or other hard plastics type of material.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The invention is not limited to the embodiments hereinbefore described but may be varied in both construction and detail.

What is claimed is:

1-10. (canceled)

11. A device, suitable for use with a beverage dispensing apparatus for dispensing a beverage, wherein said device comprises:
a first opening at one end configured to cooperate with a control flow faucet having a first dimension; and
a second opening at an opposite end of the device with respect to said first opening wherein said second opening is configured to cooperate with a shank having a second dimension to provide a flow path to dispense a beverage from said shank through said control flow faucet.

12. The device as claimed in claim 11 wherein said device comprises a threaded portion configured to cooperate with a flange of the control flow faucet.

13. The device as claimed in claim 11 wherein said device comprises a tapered portion tapered towards the opposite end to said second opening to connect with said shank.

14. The device as claimed in claim 11 wherein said device comprises a tapered portion tapered towards the opposite end to said second opening to connect with said shank, and the tapered end connects with said shank to provide a seal to create the flow path between said control flow faucet and said shank.

15. The device as claimed in claims 14 wherein part of the outer surface of said tapered portion is threaded to cooperate with said shank.

16. The device as claimed in claim 11 wherein said device comprises a threaded portion configured to cooperate with a flange of the control flow faucet and wherein said device comprises a tapered portion tapered towards the opposite end to said second opening to connect with said shank and wherein the threaded portion is separate from the tapered portion when said device is not in use.

17. The device as claimed in claim 16 wherein said threaded portion cooperates with said tapered portion in use to provide a flow path to dispense a draught beverage from said shank through said control flow faucet.

18. A beverage dispensing apparatus comprising:
a device having a first opening at one end configured to cooperate with a control flow faucet having a first dimension; and
a second opening at an opposite end of the device with respect to said first opening wherein said second opening is configured to cooperate with a shank having a second dimension to provide a flow path that enables a beverage to flow from said shank through said control flow faucet.

19. An adapter system for use in a beverage dispensing system, comprising:
a faucet;
a shank;
a device having
a first opening at one end configured to cooperate with said faucet having a first dimension; and
a second opening at an opposite end of the device with respect to said first opening wherein said second opening is configured to cooperate with said shank having a second dimension.
